(19) United States
(12) Patent Application Publication
(10) Pub. No.: US 2025/0168467 A1
(43) Pub. Date: May 22, 2025

(54) VIDEO PROCESSING METHOD, DEVICE, AND COMPUTER-READABLE STORAGE MEDIUM

(71) Applicant: Zhuhai Prometheus Vision Technology Co., Ltd., Zhuhai, Guangdong (CN)

(72) Inventors: Wei SUN, Zhuhai, Guangdong (CN); Dongfan LUO, Zhuhai, Guangdong (CN); Yu ZHANG, Zhuhai, Guangdong (CN); Zhijing SHAO, Zhuhai, Guangdong (CN); Yun LV, Zhuhai, Guangdong (CN); Enpei GUO, Zhuhai, Guangdong (CN); Yusen HU, Zhuhai, Guangdong (CN)

(21) Appl. No.: 18/246,894

(22) PCT Filed: Dec. 5, 2022
(86) PCT No.: PCT/CN2022/136595

§ 371 Date: Mar. 28, 2023

(30) Foreign Application Priority Data
Aug. 8, 2022 (CN) 202210942429.7

(51) Int. Cl. H04N 21/81; G06T 7/20; G06T 7/70; G06T 19/20; H04N 21/234

(52) U.S. Cl. CPC H04N 21/816; G06T 7/20; G06T 7/70; G06T 19/20; H04N 21/23424; G06T 2219/2004

(57) ABSTRACT

A video processing method, a device, and a computer-readable storage medium are disclosed. In the method, a behavior video of a target object is acquired; the behavior video is analyzed to obtain a behavioral intent of the target object; a target template video matching the behavioral intent among a plurality of preset three-dimensional template videos is determined, the plurality of three-dimensional template videos are three-dimensional videos related to a virtual object; and a merged video of the target object and the virtual object is generated based on the behavior video and the target template video. In this way, the video processing method not only provides three-dimensional video templates for merging, but also makes a three-dimensional performance of the merged video better.

### FIELD OF DISCLOSURE

The present disclosure relates to the field of video processing technologies, in particular to a video processing method, a device, and a computer-readable storage medium.

### BACKGROUND

With the continuous development of Internet technologies, daily life has become inseparable from the Internet. In the Internet era, with the continuous development of smart terminal technologies and the continuous reduction of traffic costs, a form of information transmission is also undergoing great changes. The information transmission has gradually developed from traditional text transmission to a combination of text, image, and video. With its characteristics of large amount of information transmission, rich content, and various presentation methods, video has increasingly become a primary transmission method of the information transmission.

### SUMMARY OF DISCLOSURE

With the development of video application technologies, many video applications can provide a video merging function, and video shooters can use video templates provided in the video application to perform merging to obtain video content merged in different scenarios. However, a current merged video is a simple splicing of two-dimensional videos, which lacks a sense of realism.

Therefore, the prior art still needs to be improved and developed.

The technical problem to be solved by the present disclosure is to provide a video processing method, a device, and a computer-readable storage medium for the above defects in the prior art, and the present disclosure can solve the problem of poor realism of merged videos in the prior art.

In order to solve the above technical problems, technical solutions adopted by the present disclosure are as follows.

A video processing method includes:
acquiring a behavior video of a target object;
analyzing the behavior video to obtain a behavioral intent of the target object;
determining a target template video matching the behavioral intent among a plurality of preset three-dimensional template videos, where the plurality of three-dimensional template videos are three-dimensional videos related to a virtual object; and
generating a merged video of the target object and the virtual object based on the behavior video and the target template video.

Preferably, the generating the merged video of the target object and the virtual object based on the behavior video and the target template video includes:
acquiring a first relative position of the target object and a behavior video photographing point;
acquiring a second relative position of the virtual object and a virtual video viewing point in the target template video, where the virtual video viewing point is a virtual position corresponding to the video photographing point;
adjusting a position of the virtual object in the target template video based on the first relative position and the second relative position; and
generating the merged video of the target object and the virtual object according to the adjusted position of the virtual object.

Preferably, the adjusting the position of the virtual object in the target template video based on the first relative position and the second relative position includes:
determining a moving direction of the virtual object based on the first relative position and the second relative position;
acquiring a three-dimensional moving template video from the plurality of preset three- dimensional template videos; and
generating a video for adjusting the position of the virtual object based on the three- dimensional moving template video and the moving direction.

Preferably, the acquiring the second relative position of the virtual object and the virtual video viewing point in the target template video, the virtual video viewing point being the virtual position corresponding to the video photographing point includes:
acquiring a preset viewing angle for viewing the target template video;
determining a virtual viewing point based on the preset viewing angle; and
determining the second relative position of the virtual viewing point and the virtual object in the target template video.

Preferably, the analyzing the behavior video to obtain the behavioral intent of the target object includes:
extracting a motion data in the behavior video; and
performing an intent matching on a preset behavioral intent database according to the motion data to obtain the behavioral intent of the target object.

Preferably, the method further includes:
if the target object is not detected in a behavior video acquisition area, randomly determining a standby template video among the plurality of three-dimensional template videos and displaying the standby template video;
if the target object is detected in the behavior video acquisition area, generating the merged video according to the behavior video of the target object and displaying the merged video.

Preferably, before the randomly determining the standby template video among the plurality of three-dimensional template videos and displaying the standby template video if the target object is not detected in the behavior video acquisition area, the method further includes:
in response to a login request of a user, acquiring barcode information displayed by the user;
determining a target account corresponding to the barcode information, and using the target account to log in.

Preferably, the method further includes:
in response to a merged video download instruction, saving the merged video in a storage location corresponding to the target account.

Preferably, the acquiring the behavior video of the target object includes:
in response to a video merging request, sending a video photographing instruction to a camera so that the camera acquires the behavior video in a preset behavior video acquisition area; and
receiving the behavior video of the target object returned by the camera.

Preferably, the in response to the video merging request, sending the video photographing instruction to the camera so that the camera acquires the behavior video in the preset behavior video acquisition area includes:
in response to the video merging request, sending a detection instruction for detecting the target object in the preset behavior video acquisition area to the camera; and
if it is determined that the target object is detected in the preset behavior video acquisition area according to a detection result returned by the camera, sending the video photographing instruction to the camera, so that the camera acquires the behavior video.

Preferably, the method further includes:
if it is determined that the target object is not detected in the preset behavior video acquisition area according to the detection result returned by the camera, sending a movement instruction to the camera, where the movement instruction is configured to control the camera to move along a preset slide rail until the target object is detected.

A video processing device includes:
an acquisition unit configured to acquire a behavior video of a target object;
an analyzing unit configured to analyze the behavior video to obtain a behavioral intent of the target object;
a determining unit configured to determine a target template video matching the behavioral intent among a plurality of preset three-dimensional template videos, where the plurality of three-dimensional template videos are three-dimensional videos related to the virtual object; and
a generation unit configured to generate a merged video of the target object and the virtual object based on the behavior video and the target template video.

A computer-readable storage medium, on which a mobile terminal lossless photographing program is stored, and when the mobile terminal lossless photographing program is executed by a processor, the steps of the above video processing method are realized.

A computer device includes a storage, a processor, and a computer program stored in the storage and capable of running on the processor, when the processor executes the computer program, the steps in the above video processing method are realized.

A computer program product includes computer programs/instructions, when the computer programs/instructions are executed by a processor, the steps in the above video processing method are realized.

In comparison with the prior art, the present disclosure provides the video processing method, the behavior video of the target object is acquired, the behavior video is analyzed to obtain the behavioral intent of the target object, the target template video matching the behavioral intent is determined among the plurality of preset three-dimensional template videos, the plurality of three-dimensional template videos are three-dimensional videos related to the virtual object, and the merged video of the target object and the virtual object is generated based on the behavior video and the target template video.

In this way, the video processing method provided by the present disclosure not only provides three-dimensional video templates for merging, but also makes a three-dimensional performance of the merged video better. Moreover, it can automatically match the most suitable three-dimensional template video for merging according to a motion intention of a merged object, making the merged video more vivid and reasonable, and greatly enhancing the realism of the merged video.

### BRIEF DESCRIPTION OF DRAWINGS

FIG. 1 is a schematic diagram of a scene of video processing in the present disclosure.

FIG. 2 is a schematic flowchart of a video processing method provided by the present disclosure.

FIG. 3 is a schematic diagram of another scene of video processing in the present disclosure.

FIG. 4 is a preview schematic diagram of a merged video.

FIG. 5 is another preview schematic diagram of a merged video.

FIG. 6 is another schematic flowchart of a video processing method provided by the present disclosure.

FIG. 7 is a schematic structural diagram of a video processing device provided by the present disclosure.

FIG. 8 is a schematic structural diagram of a computer device provided by the present disclosure.

The implementation, functional features, and advantages of the present disclosure will be further described in conjunction with the embodiments and with reference to the accompanying drawings.

### DETAILED DESCRIPTION

The technical solutions in embodiments of the present disclosure will be clearly and completely described below with reference to the drawings in the embodiments of the present disclosure. Apparently, the described embodiments are only some of the embodiments of the present disclosure, not all of them. Based on the embodiments in the present disclosure, all other embodiments obtained by those skilled in the art without creative efforts fall within the protection scope of the present disclosure.

The embodiments of the present disclosure provide a video processing method, a device, a computer-readable storage medium, and a computer device. The video processing method can be used in the video processing device. The video processing device can be integrated in the computer device, and the computer device can be a terminal or a server. The terminal can be a mobile phone, a tablet, a laptop, a smart TV, a wearable smart device, a personal computer (PC), and a vehicle-mounted terminal. The server may be an independent physical server, or may be a server cluster or a distributed database system formed by at least two physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The server can be a node in a blockchain.

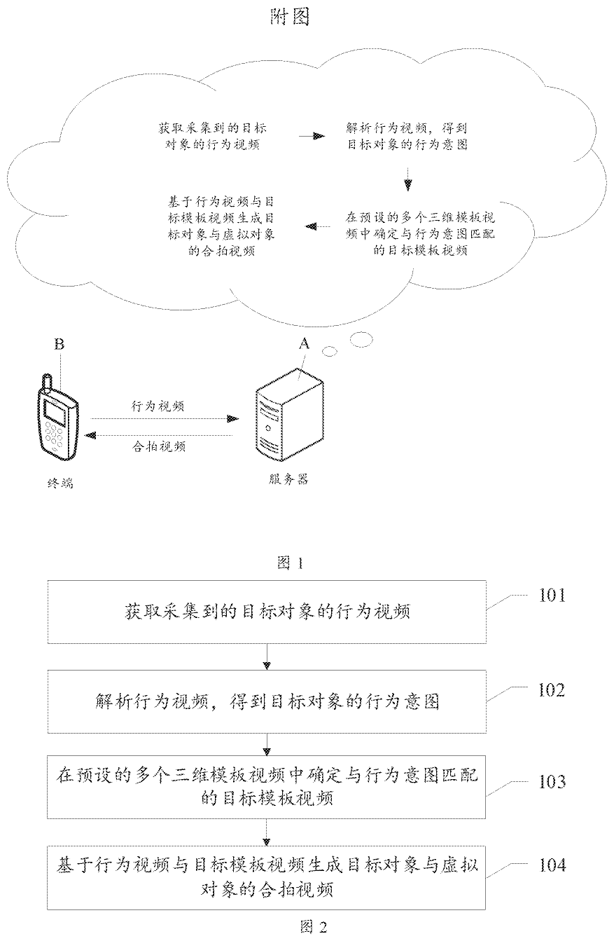

Referring to FIG. 1, which is a schematic diagram of a scene of a video processing method provided by the present disclosure. As shown in the figure, a server A acquires a behavior video of a target object from a terminal B. The behavior video is analyzed to obtain a behavioral intent of the target object. A target template video matching the behavioral intent is determined among a plurality of preset three-dimensional template videos. The plurality of three-dimensional template videos are three-dimensional videos related to a virtual object. A merged video of the target object and the virtual object is generated based on the behavior video and the target template video. The server A may further send the generated merged video to the terminal B for display.

Based on the above implementation scenarios, detailed descriptions will be given below.

In related technologies, when a video processing application is used to shoot a merged video, a template video provided in the video processing application is generally merged with a behavior video of a user to generate the merged video. However, currently provided template videos are generally two-dimensional videos. Even for some 3D video merging, merged video templates provided by it are only videos that look like 3D, and they are essentially two-dimensional template videos. When a 2D video template is merged with the captured behavior video of the user, there is often a sense of fragmentation due to inaccurate pose matching, resulting in a lack of realism in the merged video. In order to solve the above problems, the present disclosure provides a video processing method in order to improve the realism of the merged video.

Embodiments of the present disclosure will be described from the perspective of a video processing device. The video processing device can be integrated in a computer device. The computer device can be a terminal or a server. The terminal can be a mobile phone, a tablet, a laptop, a smart TV, a wearable smart device, a personal computer (PC), and a vehicle-mounted terminal. The server may be an independent physical server, or may be a server cluster or a distributed database system formed by at least two physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The server can be a node in a blockchain. As shown in FIG. 2, which is a schematic flowchart of a video processing method provided by the present disclosure, and the method includes the following.

Step 101, a behavior video of a target object is acquired.

The target object may be an object used for merging with a template video, specifically a specific person, animal, or other object. Specifically, the target object is an object with behavioral capabilities. When the target object is an object other than a person or an animal, the target object may be an object with behavioral capabilities such as a robot. The behavioral capacity may be a spontaneous behavioral capacity or a manipulated behavioral capacity.

The behavior video of the target object can be acquired by the video processing device itself, or it can be acquired by other devices and sent to the video processing device. The acquired behavior video of the target object may be acquired in real time. That is, when the behavior video of the target object is acquired by other devices and then sent to the video processing device, the video capture device sends the acquired behavior video to the video processing device with real-time data stream after capturing the behavior video of the target object.

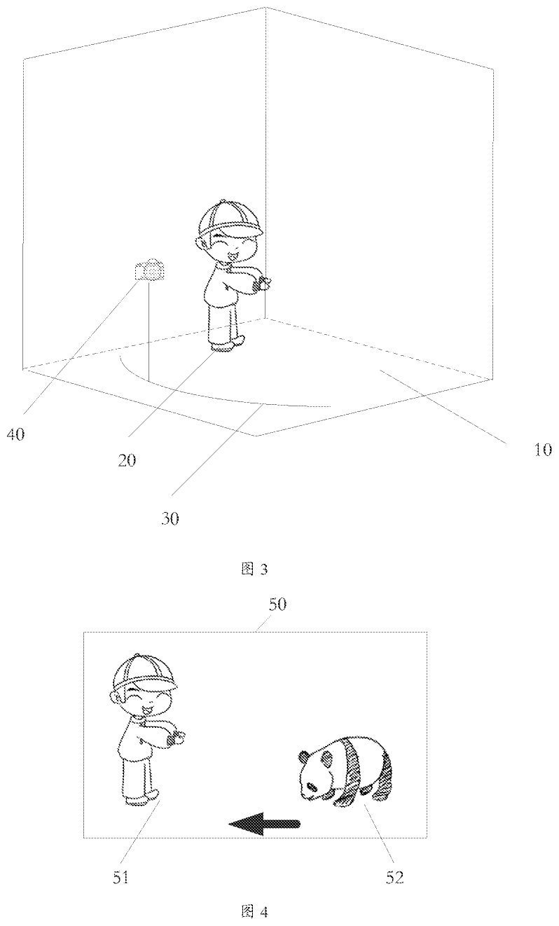

When the behavior video of the target object is acquired by the video processing device itself, the video processing device can be installed in a smart phone. The behavior video of the target object can be acquired directly with the smart phone. In this case, the target object does not need to be limited to photographing in a preset video photographing area. When the behavior video of the target object is acquired by other devices and sent to the video processing device, the behavior video of the target object can be acquired by an industrial camera. As shown in FIG. 3, which is a schematic diagram of another scene of a video processing method in the present disclosure. As shown in the figure, a behavior video acquisition of a target object 20 can be performed in a preset video acquisition area 10. Specifically, the behavior video of the target object 20 can be acquired by an industrial camera 40. The industrial camera 40 can slide on a slide rail 30 to change a position of a photographing point. When sliding on the slide rail 30, the industrial camera 40 can still determine a relative positional relationship between the current photographing position and the target object 20 in real time. After the industrial camera 40 acquires the behavior video of the target object 20, it can be sent to the video processing device in real time for display and other processing.

In some embodiments, the acquiring the behavior video of the target object includes:
1. In response to a video merging request, a video photographing instruction is sent to the industrial camera so that the industrial camera acquires a behavior video in a preset behavior video acquisition area;
2. The behavior video of the target object returned by the industrial camera is received.

That is, in the embodiment of the present disclosure, the industrial camera can be used to acquire the behavior video of the user in the preset behavior video acquisition area. When receiving the video merging request, the video processing device will send the video photographing instruction to the industrial camera to control the industrial camera to acquire the behavior video, and receive the behavior video returned by the industrial camera.

In some embodiments, the in response to the video merging request, sending the video photographing instruction to the industrial camera so that the industrial camera acquires the behavior video in the preset behavior video acquisition area includes:
1.1. In response to the video merging request, a detection instruction for detecting the target object in the preset behavior video acquisition area is sent to the camera;
1.2. If it is determined that the target object is detected in the preset behavior video acquisition area according to a detection result returned by the industrial camera, the video photographing instruction is sent to the industrial camera, so that the industrial camera acquires the behavior video.

In some cases, the industrial camera acquires the behavior video in the preset behavior video acquisition area. If the target object has not yet appeared in this area, the behavior video of the target object cannot be acquired when photographing is started at this time, so that the merged video only has a virtual object. In this case, the video processing device can first send the detection instruction to the industrial camera. The detection instruction is used to make the industrial camera detect whether the target object is found in the preset behavior video acquisition area. That is, it is detected whether the target object appears in the preset behavior video acquisition area. If it cannot be detected, the photographing and acquisition of the behavior video will not be started. If it is detected, the video processing device sends a photographing command to the industrial camera for acquiring the behavior video.

In some embodiments, the video processing method provided by the present disclosure further includes:

If it is determined that no target object is detected in the preset behavior video acquisition area according to the detection result returned by the industrial camera, a movement instruction is sent to the industrial camera. The movement instruction is configured to control the industrial camera to move along the preset slide rail until the target object is detected.

In some cases, the industrial camera has a limited field of view, and a video acquisition area cannot fully cover the entire preset behavior video acquisition area. At this time, it may happen that the user has entered the preset behavior video acquisition area, but the industrial camera cannot acquire the behavior video. In this case, the video processing device can control the industrial camera to move along its preset slide rail to find the target object until the target object is found. This method can perform automatic object finding, which can improve the photographing efficiency of the merged video.

Step 102, the behavior video is analyzed to obtain a behavioral intent of the target object.

In the embodiment of the present disclosure, after the behavior video of the target object is acquired, the behavioral intent of the target object can be recognized based on the behavior video of the target object in real time. Specifically, the behavior of the target object in the behavior video can be analyzed, and then a human motion recognition algorithm or an image motion analysis algorithm can be used to recognize the behavioral intent to obtain the behavioral intent of the target object.

In some embodiments, the analyzing the behavior video to obtain the behavioral intent of the target object includes:
1. A motion data in the behavior video is extracted;
2. An intent matching is performed on a preset behavioral intent database according to the motion data to obtain the behavioral intent of the target object.

In the embodiment of the present disclosure, a purpose of recognizing the behavioral intent of the target object is to match the most suitable three-dimensional template video. The number of three-dimensional template videos is limited, and there is a high requirement on a matching time of template matching, because when performing video merging, it is generally necessary to display the merging result in real time. Efficiently match the most accurate three-dimensional template videos and call them for display, which can prevent affecting a user experience due to stilted switching of templates. The three-dimensional template videos generally have a one-to-one correspondence with the behavioral intents of the user. The recognition of the behavioral intent of the user can actually determine the one that best matches the current user's behavior among a limited number of the behavioral intents of the user.

Specifically, after the behavior video of the user is obtained, the motion data in the behavior video may be extracted first. The motion data can include motion regions and motion types. The motion regions can be hands, arms, legs, feet, and heads. The motion types are specific motions in different motion regions, such as shaking hands, nodding, running, or jumping.

After the motion data in the behavior video is extracted, a behavioral intent tag corresponding to the motion data can be found in a preset mapping relationship table between the motion data and the behavioral intent. Also, the behavioral intent corresponding to the behavioral intent tag can be further determined in the behavioral intent database, so as to obtain the behavioral intent of the target object.

Specifically, in the process of recognizing the intention of the behavior video, related technologies of artificial intelligence (AI) are adopted. The AI is a theory, method, technology, and application system that uses a digital computer or a machine controlled by the digital computer to simulate, extend, and expand human intelligence, perceive an environment, acquire knowledge, and use knowledge to obtain an optimal result. In other words, the AI is a comprehensive technology of computer science, which attempts to understand essence of intelligence and produces a new intelligent machine that can respond in a manner similar to human intelligence. The AI is to study the design principles and implementation methods of various intelligent machines, to enable the machines to have the functions of perception, reasoning, and decision-making.

AI technology is a comprehensive discipline, and relates to a wide range of fields including both hardware-level technologies and software-level technologies. AI foundational technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning/deep learning. In the present disclosure, the computer vision technology in artificial intelligence technology is used to process and recognize the behavior images in the behavior video.

The computer vision (CV) is a science that studies how to use a machine to “see”, and furthermore, that uses a camera and a computer to replace human eyes to perform machine vision such as recognition, tracking, and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that may obtain information from images or multidimensional data. The CV technologies generally include technologies such as image processing, image recognition, image semantic understanding, image retrieval, optical character recognition (OCR), video processing, video semantic understanding, video content/behavior recognition, three-dimensional object reconstruction, a three dimensional (3D) technology, virtual reality, augmented reality, synchronous positioning, or map construction, and further include biological feature recognition technologies such as common face recognition and fingerprint recognition.

Step 103, a target template video matching the behavioral intent is determined among a plurality of preset three-dimensional template videos.

The plurality of three-dimensional template videos are template three-dimensional videos related to a virtual object. Here, the virtual object may be any virtual object such as a virtual animal or a virtual character. For example, the virtual object may be a virtual animal such as a virtual giant panda, a giraffe, or a kangaroo. The virtual object can also be a virtual public figure, such as a star, a scientist, or an astronaut.

Here, the three-dimensional videos are videos generated by photographing virtual objects from multiple angles. Specifically, the three-dimensional videos here may be volumetric videos. Traditional two-dimensional video is a dynamic image formed by continuous switching of multiple static images per second. The volumetric video is a three-dimensional video composed of multiple 3D static models per second through continuous playback. The production of the volumetric video is generally divided into three steps. A first step is data acquisition. Performers (can be human or animal) need to perform in a pre-set spherical matrix. Nearly a hundred ultra-high-definition industrial cameras in the spherical matrix will acquire all the data of the performers. A second step is algorithm generation. The cameras will upload the data acquired in the spherical matrix to a cloud. Algorithm reconstruction of the data is carried out through the self-developed algorithm, and finally the volumetric video is generated. A third step is to place the generated volumetric video in various scenarios according to usage requirements. It can be placed in a virtual scene, or placed in a real scene through AR technology. For each 3D static model of the volumetric video, the viewer is allowed to move freely inside the content and to view the photographed object from different points of views and distances. Viewing the same subject from different perspectives can result in different images. The volumetric video essentially breaks the limitations of traditional two-dimensional video, and can acquire and record data on the subject in all directions, so that it can display the photographed object in 360 degrees.

The volumetric video (also known as spatial video, three-dimensional videos, or 6-DOF video) is a technology that captures information in three-dimensional space (such as depth information and color information, etc.) and generates a three-dimensional model sequence. Compared with traditional video, the volumetric video adds a concept of space to video. Use a 3D model to better restore the real 3D world, instead of using a 2D plane video plus a camera movement to simulate the sense of space in the real 3D world. Since the volumetric video is essentially a sequence of 3D models, users can adjust it to any viewing angle to watch according to their preferences, which has a higher degree of restoration and immersion than 2D plane video.

Alternatively, in the present disclosure, the 3D model used to form the volumetric video can be reconstructed as follows:

First, color images and depth images of different viewing angles of the subject and camera parameters corresponding to the color images are acquired. Then, according to the acquired color image and its corresponding depth image and camera parameters, a neural network model that implicitly expresses the 3D model of the subject is trained. Also, based on the trained neural network model, an iso-surface is extracted to realize the three-dimensional reconstruction of the photographed object and obtain the three-dimensional model of the photographed object.

It should be noted that, in the embodiment of the present disclosure, there is no specific limitation on the architecture of the neural network model, which can be selected by those skilled in the art according to actual needs. For example, a multilayer perceptron (MLP) without a normalization layer can be selected as a basic model for model training.

The 3D model reconstruction method provided by the present disclosure will be described in detail below.

First of all, multiple color cameras and depth cameras can be used simultaneously to take multi-angle shots of the target object that needs to be 3D reconstructed (the target object is the photographed object), to obtain the color images and corresponding depth images of the target object in multiple different viewing angles. That is, at the same photographing time (a difference between an actual photographing time is less than or equal to a time threshold, the photographing time is considered the same), the color cameras of each viewing angle will acquire the color images of the target object at the corresponding viewing angles. Correspondingly, the depth cameras of each viewing angle will acquire the depth images of the target object at the corresponding viewing angles. It should be noted that the target object may be any object, including but not limited to, living objects such as people, animals, and plants, or non-living objects such as machinery, furniture, and dolls.

In this way, the color images of the target object at different viewing angles all have corresponding depth images. That is, when photographing, the color camera and depth camera can adopt the configuration of camera groups. The color camera with the same viewing angle cooperates with the depth camera to shoot the same target object synchronously. For example, a studio can be built. A central area of the studio is the photographing area. Surrounding the photographing area, a plurality of groups of color cameras and depth cameras are paired and set at intervals of a certain angle in a horizontal direction and a vertical direction. When the target object is in the photographing area surrounded by these color cameras and depth cameras, color images of the target object at different viewing angles and corresponding depth images can be acquired by these color cameras and depth cameras.

In addition, camera parameters of the color cameras corresponding to each of the color images are further obtained. The camera parameters include internal and external parameters of the color camera, which can be determined through calibration. The internal parameters of the camera are parameters related to the characteristics of the color camera itself, including but not limited to, the focal length, pixels, and other data of the color camera. The external parameters of the camera are the parameters of the color camera in a world coordinate system, including but not limited to, a position (coordinates) of the color camera and a rotation direction of the camera.

As above, after acquiring multiple color images of different viewing angles and their corresponding depth images at the same photographing moment of the target object, three-dimensional reconstruction of the target object can be performed based on these color images and their corresponding depth images. A difference from a method of converting depth information into point cloud for 3D reconstruction in related technologies is that the present disclosure trains the neural network model to realize the implicit expression of the 3D model of the target object, so as to realize the 3D reconstruction of the target object based on the neural network model.

Alternatively, the present disclosure selects a multilayer perceptron (MLP) that does not include a normalization layer as the basic model, and performs training as follows:

Pixels in each color image are converted into rays based on the corresponding camera parameters;

A plurality of sampling points are sampled on the ray, and a first coordinate information of each sampling point and a SDF value of each sampling point from the pixel are determined;

The first coordinate information of the sampling points is input into a basic model, and a predicted SDF value and a predicted RGB color value of each sampling point output by the basic model are obtained;

Based on a first difference between the predicted SDF value and the SDF value, and a second difference between the predicted RGB color value and a RGB color value of the pixel, parameters of the basic model are adjusted until a preset stopping condition is met;

The basic model that satisfies the preset stopping condition is used as a neural network model that implicitly expresses the 3D model of the target object.

First, a pixel in the color image is converted into a ray based on the camera parameters corresponding to the color image. The ray may be a ray that passes through the pixel and is perpendicular to a plane of the color image. Then, a plurality of sample points on the ray are sampled. The sampling process of sampling points can be performed in two steps. Part of the sampling points can be evenly sampled first, and then multiple sampling points are further sampled at key points based on a depth value of the pixel to ensure that as many sampling points as possible can be sampled near a surface of the model. Then, the first coordinate information of each sampled point in a world coordinate system and a signed distance field (SDF) value of each sampled point are calculated according to the camera parameters and the depth value of the pixel. The SDF value may be a difference between the depth value of the pixel and a distance between the sampling point and an imaging plane of the camera. The difference is a signed value. When the difference is positive, it means that the sampling point is outside the 3D model. When the difference is negative, it means that the sampling point is inside the 3D model. When the difference is zero, it means that the sampling point is on the surface of the 3D model. Then, after completing the sampling of the sampling points and calculating the SDF value corresponding to each sampling point, the first coordinate information of the sampling point in the world coordinate system is further input into the basic model (the basic model is configured to map the input coordinate information into SDF values and RGB color values and then output). The SDF value output by the basic model is recorded as the predicted SDF value, and the RGB color value output by the basic model is recorded as the predicted RGB color value. Then, based on the first difference between the predicted SDF value and the SDF value corresponding to the sampling point and the second difference between the predicted RGB color value and the RGB color value of the pixel corresponding to the sampling point, the parameters of the basic model are adjusted.

In addition, for other pixels in the color image, sampling points are sampled in the same way as above, and then the coordinate information of the sampling points in the world coordinate system is input to the basic model to obtain the corresponding predicted SDF value and predicted RGB color value, which are used to adjust the parameters of the basic model until the preset stopping condition is satisfied. For example, the preset stopping condition can be configured as the number of iterations of the basic model reaches the preset number, or the preset stopping condition can be configured as the basic model converges. When the iteration of the basic model satisfies the preset stop condition, a neural network model capable of accurately and implicitly expressing the three-dimensional model of the photographed object is obtained. Finally, marching cubes can be used to extract the surface of the three-dimensional model of the neural network model, so as to obtain the three-dimensional model of the photographed object.

Alternatively, in some embodiments, the imaging plane of the color image is determined according to the camera parameter. It is determined that a ray passing through the pixel in the color image and perpendicular to the imaging plane is the ray corresponding to the pixel.

The coordinate information of the color image in the world coordinate system may be determined according to the camera parameters of the color camera corresponding to the color image, that is, the imaging plane may be determined. Then, it can be determined that the ray passing through the pixel in the color image and perpendicular to the imaging plane is the ray corresponding to the pixel.

Alternatively, in some embodiments, second coordinate information and a rotation angle of the color camera in the world coordinate system are determined according to the camera parameters. The imaging plane of the color image is determined according to the second coordinate information and the rotation angle.

Alternatively, in some embodiments, a first number of first sampling points are sampled at equal intervals on the ray. A plurality of key sampling points are determined according to the depth values of pixels, and a second number of second sampling points are sampled according to the key sampling points. The first number of first sampling points and the second number of second sampling points are determined as a plurality of sampling points obtained by sampling on the ray.

First, n (i.e., the first number) first sampling points are uniformly sampled on the ray, where n is a positive integer greater than 2. Then, according to the depth values of the aforementioned pixel, a preset number of key sampling points closest to the aforementioned pixel are determined from the n first sampling points. Alternatively, a key sampling point whose distance from the preceding pixel is less than a distance threshold is determined from the n first sampling points. Then, according to the determined key sampling points, m second sampling points are sampled, m is a positive integer greater than 1. Finally, the n+m sampling points obtained by sampling are determined as the plurality of sampling points obtained by sampling on the ray. Sampling more m sampling points at the key sampling points can make the training effect of the model more accurate on the surface of the 3D model, thereby improving the reconstruction accuracy of the 3D model.

Alternatively, in some embodiments, the depth values corresponding to the pixels are determined according to the depth image corresponding to the color image. The SDF value of each sampling point from the pixel is calculated based on the depth value. The coordinate information of each sampling point is calculated according to the camera parameters and the depth value.

After sampling the plurality of sampling points on the ray corresponding to each pixel, for each sampling point, a distance between a shooting position of the color camera and a corresponding point on the target object according to the camera parameters and the depth value of the pixel. Then, based on the distance, the SDF value of each sampling point is calculated one by one and the coordinate information of each sampling point is calculated.

It should be noted that after the training of the basic model is completed, for a given coordinate information of any point, the corresponding SDF value can be predicted by the basic model that has completed the training. The predicted SDF value represents the positional relationship (inside, outside, or surface) between the point and the three-dimensional model of the target object. The implicit expression of the three-dimensional model of the target object is realized, and the neural network model used for implicitly expressing the three-dimensional model of the target object is obtained.

Finally, the iso-surface of the above neural network model is extracted to obtain the surface of the three-dimensional model. For example, marching cubes can be used to draw the surface of the three-dimensional model. Then, the three-dimensional model of the target object is obtained according to the surface of the three-dimensional model.

The three-dimensional reconstruction solution provided by the present disclosure uses the neural network to implicitly construct the three-dimensional model of the target object, and adds depth information to improve the speed and accuracy of model training. Using the three-dimensional reconstruction solution provided by the present disclosure, the three-dimensional reconstruction of the photographed object is continuously performed in time sequence, and the three-dimensional model of the photographed object at different times can be obtained. A three-dimensional model sequence formed by these three-dimensional models at different times in time sequence is the volumetric video obtained by photographing the photographed object. In this way, “volumetric video photographing” can be performed on any photographed object to obtain a volumetric video presented by specific content. For example, a volumetric video of a dancing photographed object can be shot to obtain a volumetric video of the dance of the photographed object that can be viewed at any angle, and a volumetric video of the photographed object in the teaching can be shot to obtain the volumetric video of the teaching of the photographed object that can be viewed at any angle, etc.

It should be noted that the volumetric video related in the following embodiments of the present disclosure can be acquired by the above volumetric video photographing method.

The multiple template three-dimensional videos of the virtual object, (that is, the multiple volumetric videos of the virtual object) can be multiple volumetric videos obtained by photographing the virtual object multiple times. The volumetric video of each virtual object can correspond to an action topic, which corresponds to the behavioral intent of the target object. For example, taking a virtual object as a public figure as an example, a template volumetric video of the virtual object during handshake can be acquired. The action topic of this template volumetric video is handshake. When performing intent recognition on the acquired behavior video of the target object and determining that the intention of the target object is the handshake, it can be determined that the template volumetric video matching the behavior video of the target object is a template volumetric video whose action topic is handshake. For another example, if the virtual object is a giant panda as an example, the template volumetric video of the giant panda while eating can be shot. The action topic of this volumetric video template is eating. When performing intent recognition on the acquired behavior video of the target object and determining that the intent of the target object is feeding, it can be determined that the template volumetric video matching the behavior video of the target object is the template volumetric video whose action topic is eating. That is, the target template video can be obtained by matching the behavioral intent of the target object.

It can be understood that, when the foregoing template volumetric video is used for video merging, only multiple template volumetric videos of one virtual object are provided at one time. For example, volumetric videos of the giant panda while eating, crawling, or sleeping are provided. The invocation of these template volumetric videos can change according to the behavioral intent of the target object. For example, when the behavioral intent of the target object changes from beckoning to feeding, the template volumetric video of the invoked virtual giant panda will change from the template volumetric video of the virtual panda crawling towards the target object to the template volumetric video of eating.

Step 104, a merged video of the target object and the virtual object is generated based on the behavior video and the target template video.

After determining the target template video matching the behavioral intent of the target object, the merged video of the target object and the virtual object can be further generated based on the target template video and the acquired behavior video of the target object.

The video processing method provided by the present disclosure is a combination of the target object and the volumetric video template of the virtual object. Since the volumetric video of the virtual object can display the virtual object from all directions, the target object can be merged from different angles to obtain video results from different angles, which can greatly improve the realism of video merging. Moreover, in the embodiment of the present disclosure, there is no need to select a template video that needs to be merged with the target object. The video processing device can automatically recognize the behavioral intent of the target object, and automatically match the most suitable template volumetric video based on the behavioral intent for merging, making the generated merged video more reasonable and greatly improving the shooting efficiency of the merged video.

In some embodiments, the merged video of the target object and the virtual object is generated based on the behavior video and the target template video, and which includes the following:
1. A first relative position of the target object and a behavior video photographing point is acquired;
2. A second relative position of the virtual object and a virtual video viewing point in the target template video is acquired, where the virtual video viewing point is a virtual position corresponding to the video photographing point;
3. A position of the virtual object in the target template video is adjusted based on the first relative position and the second relative position;
4. The merged video of the target object and the virtual object is generated according to the adjusted position of the virtual object.

In the embodiment of the present disclosure, when the merged video of the target object and the virtual object is generated according to the target template video and the behavior video, a position recognition of the target object and the virtual object can be performed automatically. Since the three-dimensional template videos corresponding to the virtual object are volumetric videos constructed from data acquired by a large number of industrial cameras in a stereo studio, viewing the virtual object from different angles can obtain videos of different angles of the virtual object. The behavior of the target object is acquired in real time to obtain a behavior video, which is a video obtained by shooting based on a single angle. Even if the single angle can be adjusted, because the acquired behavior video is a two-dimensional video, the behavior video can only be acquired from one angle. This angle can be called the behavior video photographing point. For details, refer to FIG. 3, the position of the industrial camera 40 is the position of the video photographing point. The relative position of the target object 20 relative to the industrial camera 40 is the first relative position.

When acquiring the behavior video of the target object, the target object can be placed in the behavior video acquisition area for performing the behavior video acquisition, and then the camera can be used to perform the behavior video acquisition for the target object in the behavior video acquisition area. It is also possible to directly use a mobile phone to acquire the behavior video of the target object without setting the behavior video acquisition area. Whether the camera is used for the behavior video acquisition or the mobile phone is used for the behavior video acquisition, the first relative position of the target object relative to the behavior video photographing point can be obtained. Then, based on the first relative position, the second relative position of the virtual object and the virtual video viewing point in the target template video is determined. Here, the virtual video viewing point is one of multiple viewing points of the volumetric video corresponding to the target template video, and the position of the virtual viewing point corresponds to the position of the video photographing point corresponding to the behavior video of the target object. Specifically, for example, if the behavior video is acquired in a preset video acquisition area, such as a studio, then it is assumed that the volumetric video of the virtual object is also recorded in the studio. During recording, the video data acquired by the industrial camera corresponding to the position of the video photographing point where the behavior video is acquired is the data that is merged with the currently acquired behavior video. When the position of the video photographing point moves, for example, a camera with a slide rail is used to acquire the behavior video, the data merged with the currently acquired behavior video is the data acquired by the industrial camera corresponding to the position of the moved camera.

That is, in the video processing method provided by the present disclosure, when a behavior video acquisition device acquires the behavior video of the target object, if a position of the behavior video acquisition device changes, the template video data merged with the acquired behavior video will also change following the change of the position of the video acquisition device.

Furthermore, after determining the first relative position of the target object and the behavior video photographing point and the second relative position of the virtual object and the virtual video viewing point in the target template video, the position of the virtual object can be further adjusted based on the first relative position and the second relative position. For example, when the target object is a user acquired by the merged video, the virtual object is a virtual giant panda. If it is determined that a distance between the user and the giant panda is relatively long according to the first relative position and the second relative position, a virtual space position of the three-dimensional template video can be automatically adjusted at this time. For example, an overall translation adjustment is performed so that the virtual giant panda is close to the user's position, thereby forming an effective merging.

In some embodiments, the acquiring the second relative position of the virtual object and the virtual video viewing point in the target template video, the virtual video viewing point being the virtual position corresponding to the video photographing point includes:
2.1. A preset viewing angle for viewing the target template video is acquired;
2.2. A virtual viewing point is determined based on the preset viewing angle;
2.3. The second relative position of the virtual viewing point and the virtual object in the target template video is determined.

In the embodiment of the present disclosure, since the target template video is the volumetric video, viewing the volumetric video from different angles will result in different 2D videos. Video merging only needs to use a two-dimensional video with one viewing angle, so at this time, an initial viewing angle of the target template video can be preset as the preset viewing angle. For example, it is set to the viewing angle of a face of the virtual object. After obtaining the preset viewing angle of the template video, the virtual viewing point for viewing the target template video can be determined. Furthermore, a relative position between the virtual viewing point and the virtual object can be determined, that is, the second relative position.

In some embodiments, the adjusting the position of the virtual object in the target template video based on the first relative position and the second relative position includes:
3.1. A moving direction of the virtual object is determined based on the first relative position and the second relative position;
3.2. A three-dimensional moving template video is acquired from the plurality of preset three-dimensional template videos;
3.3. A video for adjusting the position of the virtual object is generated based on the three-dimensional moving template video and the moving direction.

In some embodiments, during video merging, the merged video can be previewed in real time. After the behavior video acquisition device acquires the behavior video and determines the corresponding target template video based on it, it can determine the relative position between the virtual object and the target object in the merged video in real time according to the aforementioned relative position and display it in a preview interface. At this time, if the three-dimensional template corresponding to the virtual object in the three-dimensional template video is translated directly, a skipping of a picture will appear during display, thereby reducing the sense of reality. Therefore, the embodiment of the present disclosure provides another three-dimensional template videos using a virtual object to optimize the change. Specifically, after the aforementioned first relative position and second relative position are determined, the moving direction in which the virtual object needs to move can be determined based on the first relative position and second relative position. Then, the three-dimensional moving template video of the virtual object can be obtained from the plurality of preset three-dimensional template videos. For example, when the virtual object is a virtual giant panda, the three-dimensional moving template video may be a crawling video of the virtual giant panda. Furthermore, a video for adjusting the position of the virtual object can be generated based on the three-dimensional moving template video and the previously determined moving direction. That is, a video of the virtual giant panda crawling towards a target object can be generated. In this way, the position movement of the giant panda can be made more vivid, which further enhances the sense of reality of video merging and greatly improves the user experience.

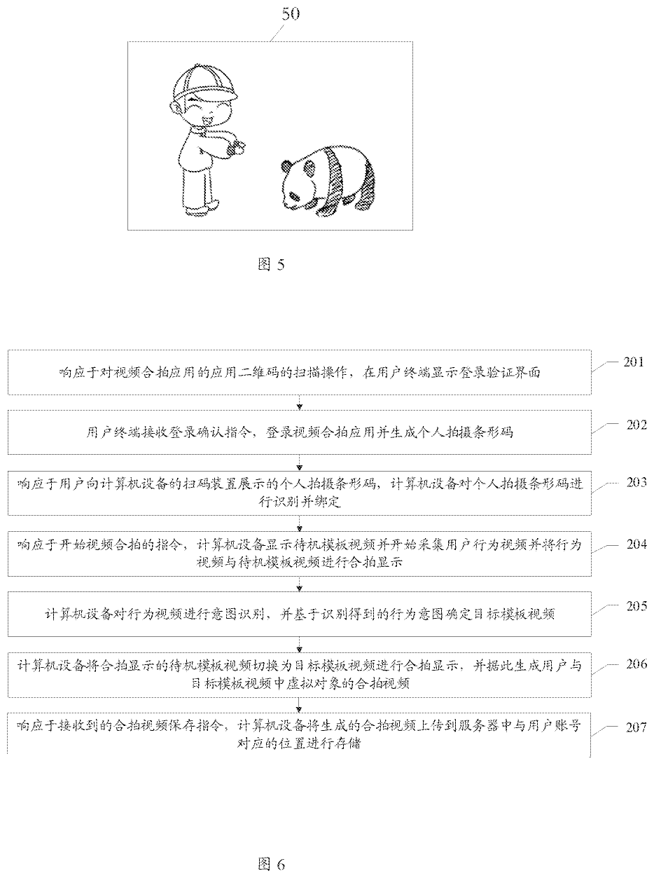

Specifically, after the behavior video of the target object is acquired, the merging result of the behavior video and the three-dimensional video of the target template can be previewed and displayed on the display screen of the video processing device. As shown in FIG. 4, which is a preview schematic diagram of the merged video of the target object and the virtual object. As shown in the figure, on a display interface 50 of the video processing device, a target object image 51 corresponding to the target object 20 and a virtual object image 51 corresponding to the virtual object are displayed. When it is recognized that the virtual object image 52 is far from the target object image 51, the three-dimensional moving template video of the virtual object can be automatically extracted, and a crawling direction is set as a direction from the virtual object image to the target object image. In this way, a dynamic video of the virtual object crawling towards the target object will be displayed on the display interface 50 of the video processing device until a distance between the virtual object image and the target object image is less than a preset value. As shown in FIG. 5, when the distance between the virtual object image and the target object image is less than the above preset value, the merged video can be changed from the three-dimensional moving template video to the target template video for display and preview. The above target object image and the virtual object image are only the corresponding preview result when the industrial camera acquires the behavior video of the target object from an angle. When the industrial camera slides along the slide rail, videos from other angles of the target object can be acquired. Then, the virtual object image corresponding to the virtual object displayed at this time will also change with the change of the acquisition angle of the industrial camera, and it will be displayed as an image viewed from other angles of the virtual object. For example, when the industrial camera moves to a front of the target object, since the target object and the virtual object are opposite in the preview video, what is displayed in the preview video is a back of the virtual object.

In some embodiments, the video processing method provided by the present disclosure further includes:
A. If the target object is not detected in a behavior video acquisition area, a standby template video among the plurality of three-dimensional template videos is randomly determined and the standby template video is displayed;
B. If the target object is detected in the behavior video acquisition area, the merged video is generated according to the behavior video of the target object and the merged video is displayed.

In the embodiment of the present disclosure, when the merging process of the merged video is previewed in real time (for example, after the user logs into the application), the preview video of the merged video is displayed on the display interface of the terminal. If the behavior video acquisition device does not acquire the behavior video at this time (for example, no target object is detected in the behavior video acquisition area), at this point, any one of the plurality of three-dimensional template videos can be displayed on the display interface of the terminal as the standby template video. For example, a video of a virtual giant panda crawling, or a video of a virtual giant panda eating, etc. are displayed. When the target object is detected in the behavior video acquisition area (for example, when a user walks into the video acquisition area, or when the user points the video acquisition device at the target object), the behavior video acquisition of the target object can be performed. Then, the target template video is determined according to the acquired behavior video, and merge them.

In some embodiments, when the standby template video is different from the target template video, a transitional three-dimensional video may also be generated based on the difference between the two. Then, the change from the standby template video to the target template video is realized by the transitioning three-dimensional video.

In some embodiments, before the randomly determining the standby template video among the plurality of three-dimensional template videos and displaying the standby template video if the target object is not detected in the behavior video acquisition area, the method further includes:
a. In response to a login request of a user, barcode information displayed by the user is acquired;
b. A target account corresponding to the barcode information is determined, and the target account is used to log in.

In the embodiment of the present disclosure, a method that can promote the use of the video merging method provided by the present disclosure is also provided. Specifically, a corresponding video merging application can be used. When using the application for the first time, the user can issue a user login request, and then user authentication and login can be performed based on the identity information corresponding to the user. The identity information of the user may be in a form of an account password, or in a form of displaying a barcode to the video processing device. The barcode here can be a one-dimensional barcode or a two-dimensional barcode. When the identity information of the user is barcode information, the video processing device may determine a target account corresponding to the barcode information according to the acquired barcode information, and then log in to the target account.

In some embodiments, the video processing method provided by the present disclosure further includes:

In response to a merged video download instruction, the merged video is saved in a storage location corresponding to the target account.

After the video is merged, the embodiment of the present disclosure can further download, playback, and forward the generated merged video.

Specifically, in some embodiments, for storing the merged video, the generated merged video may also be stored in a cloud server. Cloud storage is a new concept extended and developed from a concept of cloud computing. A distributed cloud storage system (hereinafter referred to as a storage system) is a storage system that integrates a large number of different types of storage devices (also referred to as storage nodes) in a network through application software or application interfaces to work together by using functions such as a cluster application, a grid technology and a distributed storage file system, to jointly provide functions of data storage and business access to the outside.

Currently, a storage method of the storage system is creating logical volumes. When creating the logical volumes, a physical storage space is allocated for each logical volume. The physical storage space may be composed of a storage device or disks of several storage devices. A client stores data on a logical volume, that is, the data is stored on a file system. The file system divides the data into many parts, each part is an object. The objects includes not only data but also additional information such as data identification (ID, ID entity). The file system writes each object individually to the physical storage space of the logical volume. Moreover, the file system will record storage location information of each object, so that when the client requests to access data, the file system can allow the client to access the data according to the storage location information of each object.

A process of the storage system allocating the physical storage space for the logical volume is as follows: according to a capacity estimation of the object stored in the logical volume (this estimation often has a large remaining capacity relative to the capacity of the actual object to be stored) and redundant array of independent disk (RAID) group, the physical storage space is divided into stripes in advance, and one logical volume can be understood as one stripe, thereby allocating the physical storage space for the logical volume.

According to the above description, in the video processing method provided by the embodiment of the present disclosure, the behavior video of the target object is acquired. The behavior video is analyzed to obtain the behavioral intent of the target object. The target template video matching the behavioral intent among the plurality of preset three-dimensional template videos is determined. The plurality of three-dimensional template videos are three-dimensional videos related to the virtual object. The merged video of the target object and the virtual object is generated based on the behavior video and the target template video.

In this way, the video processing method provided by the present disclosure not only provides three-dimensional video templates for merging, but also makes a three-dimensional performance of the merged video better. Moreover, it can automatically match the most suitable three-dimensional template video for merging according to a motion intention of a merged object, making the merged video more vivid and reasonable, and greatly enhancing the realism of the merged video.

The present disclosure also provides a video processing method, as shown in FIG. 6, which is another schematic flowchart of a video processing method provided by the present disclosure. The method specifically includes the following:

Step 201, in response to a scanning operation of an application two-dimension code of a video merging application, a login verification interface is displayed on a user terminal.

In the embodiment of the present disclosure, a volumetric video-based merging technique will be described in detail. Specifically, the present disclosure can provide a volumetric video-based merging system. Specifically, the system may include a computer device loaded with a volumetric video merging application, a user terminal loaded with the volumetric video merging application, a movable industrial camera, and a preset behavior video acquisition area. The preset behavior video acquisition area here can be a studio.

Before shooting, the user can first log in to the volumetric video merging application in the user terminal, and then use a code scanning function in the application to scan the application two-dimension code of the video merging application. Here, the application two-dimension code of the video merging application may be a two-dimension code displayed on a cardboard, or a two-dimension code displayed in a display interface of a computer device. The video merging application here is the aforementioned video merging application based on volumetric video. In some embodiments, the user can also scan the application two-dimension code of the video merging application by using the code scanning function of an instant messaging application (such as WeChat or Alipay) loaded in the user terminal. After scanning the application two-dimension code of the video merging application, the login verification interface of the video merging application will be displayed on the user terminal. The user can key in the user's verification information in the interface, or use a third-party login method for login verification, so as to determine the identity of the user who is about to merge the videos.

Step 202, the user terminal receives a login confirmation instruction, logs into the video merging application, and generates a personal photographing barcode.

When the user enters the verification information in the user terminal and confirms the login, the user can log in to the aforementioned video merging application, and the personal photographing barcode is generated.

Step 203, in response to the personal photographing barcode presented by the user to a code scanning device of the computer device, the computer device identifies and binds the personal photographing barcode.

Furthermore, the user can display the personal photographing barcode generated in step 202 to the code scanning device of the computer device loaded with the video merging application to trigger the computer device to start the video merge corresponding to the user identity. After the code scanning device of the computer device acquires the personal photographing barcode, it identifies the personal photographing barcode to extract the identity information contained therein. Then, a current photographing task is bound with the identity information, so that users who only have the identity information can view the currently photographing merged volumetric video, thereby avoiding leakage of personal privacy.

Step 204, in response to an instruction to start video merging, the computer device displays a standby template video, starts acquiring a behavior video of the user, and merges the behavior video and the standby template video for display.

After the computer device binds the user's identity, it can receive a photographing control instruction of the user. Specifically, when the user clicks the control to start video merging, or uses voice control to control the start of video merging, the computer device randomly determines one standby template video from a plurality of template volumetric videos to display. Apparently, before displaying, the user can also select a merged object, for example, select the merged object as an animal or a public figure. After the merged object is selected, the computer device calls out multiple template volumetric videos corresponding to the merged object from a template database for merging. Then, when the user decides to start video merging, one standby template video may be randomly determined from the multiple template volumetric videos to be played and displayed. For example, when the merged object is a virtual giant panda, multiple template volumetric videos of the virtual giant panda can be called out, such as a volumetric video of crawling, a volumetric video of playing, a volumetric video of eating, and a volumetric video of sleeping. The standby template video can be randomly determined as the sleeping template video, etc.

After the video merge is enabled and the standby template video is displayed on the computer device, the industrial camera starts to acquire the behavior video of the user in the preset behavior video acquisition area. If the industrial camera does not acquire the behavior video of the user (for example, the user does not enter the preset video acquisition area), the standby template video will continue to be shown in the display interface of the computer device. If the industrial camera has acquired the behavior video of the user, the behavior video of the user will be merged with the standby template video.

Step 205, the computer device performs intent recognition on the behavior video, and determines a target template video based on the recognized behavioral intent.

During the video merging process, the computer device also performs intent recognition on the behavior video of the user. For example, if it is recognized that the user wants to play with a virtual giant panda, then the standby template video will be changed to a volumetric video of playing. Then, a preview video of the user playing with the virtual giant panda is displayed on the display interface of the computer device. Since the preview video is a two-dimensional video, the user behavior video acquired by the industrial camera is also a two-dimensional video. The template video (i.e., the aforementioned volumetric video of playing) is a volumetric video. That is, the preview video (i.e., the merged video) is a two-dimensional video generated by synthesizing the user behavior video (two-dimensional video) and the two-dimensional video viewed from a viewing angle of the template volumetric video. The viewing angle of the template volumetric video can be determined according to a position of the industrial camera. That is, a virtual viewing position for viewing the volumetric video is determined according to the position of the industrial camera relative to the preset behavior video acquisition area. After the virtual viewing position for viewing the template volumetric video is determined, the two-dimensional video of the angle corresponding to the template volumetric video for merging can be determined. When the industrial camera slides on the slide rail, the corresponding virtual viewing position for viewing the template volumetric video will also change accordingly. That is, the viewing angle of the two-dimensional video corresponding to the virtual object in the merged video will also change accordingly. In the prior art, according to the three-dimensional video obtained by triangulating the two-dimensional video, when the video is merged, the change of a photographing angle will not affect the viewing angle of the three-dimensional video. The merged content of the three-dimensional video does not change, resulting in a lower sense of realism of merging. Therefore, this method can greatly improve the sense of reality of merging.

Step 206, the computer device changes the merged and displayed standby template video to the target template video for merging and displaying, and accordingly generates the merged video of the user and the virtual object in the target template video.

After determining the behavioral intent of the acquired behavior video and determining the target template video corresponding to the behavioral intent, it can be switched to merge the user and the volumetric video of the target template video to generate the merged video of the user and the virtual object.

Step 207, in response to a received merged video saving instruction, the computer device uploads the generated merged video to a location corresponding to a user account in a server for saving.

Furthermore, after the video merging is completed, the user can also click a saving control in the computer device. The computer device will upload the acquired merged video to the server. The server will save the merged video in the location corresponding to the user account, so that the user can subsequently log in to the corresponding account to view the merged video taken by the user.

According to the above description, in the video processing method provided by the embodiment of the present disclosure, the behavior video of the target object is acquired, the behavior video is analyzed to obtain the behavioral intent of the target object, the target template video matching the behavioral intent is determined among the plurality of preset three-dimensional template videos, the plurality of three-dimensional template videos are three-dimensional videos related to the virtual object, and the merged video of the target object and the virtual object is generated based on the behavior video and the target template video.

In this way, the video processing method provided by the present disclosure not only provides three-dimensional video templates for merging, but also makes a three-dimensional performance of the merged video better. Moreover, it can automatically match the most suitable three-dimensional template video for merging according to a motion intention of a merged object, making the merged video more vivid and reasonable, and greatly enhancing the realism of the merged video.

In order to better implement the above video processing method, an embodiment of the present disclosure further provides a video processing device, which can be integrated in a terminal or a server.

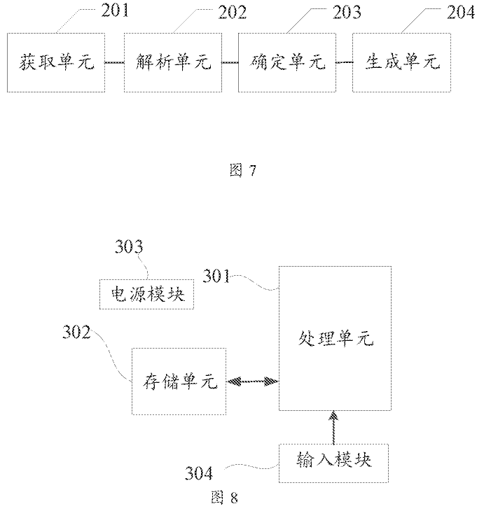

For example, as shown in FIG. 7, which is a schematic structural diagram of a video processing device provided by an embodiment of the present disclosure. The video processing device may include an acquisition unit 201, an analyzing unit 202, a determining unit 203, and a generation unit 204.

The acquisition unit 201 is configured to acquire a behavior video of a target object;

The analyzing unit 202 is configured to analyze the behavior video to obtain a behavioral intent of the target object;

The determining unit 203 is configured to determine a target template video matching the behavioral intent among a plurality of preset three-dimensional template videos, the plurality of three-dimensional template videos are three-dimensional videos related to the virtual object;

The generation unit 204 is configured to generate a merged video of the target object and the virtual object based on the behavior video and the target template video.

In some embodiments, the generation unit includes the following:

A first acquisition subunit is configured to acquire a first relative position of the target object and a behavior video photographing point;

A second acquisition subunit is configured to acquire a second relative position of the virtual object and a virtual video viewing point in the target template video, the virtual video viewing point is a virtual position corresponding to the video photographing point;

An adjustment subunit is configured to adjust a position of the virtual object in the target template video based on the first relative position and the second relative position;

A first generation subunit is configured to generate the merged video of the target object and the virtual object according to the adjusted position of the virtual object.

In some embodiments, the adjustment subunit includes the following:

A determining module is configured to determine a moving direction of the virtual object based on the first relative position and the second relative position;

An acquisition module is configured to acquire a three-dimensional moving template video from the plurality of preset three-dimensional template videos;

A generation module is configured to generate a video for adjusting the position of the virtual object based on the three-dimensional moving template video and the moving direction.

In some embodiments, the analyzing unit includes the following:

An extracting subunit is configured to extract a motion data in the behavior video;

A matching subunit is configured to perform an intent matching on a preset behavioral intent database according to the motion data to obtain the behavioral intent of the target object.

In some embodiments, the video processing device provided by the present disclosure further includes the following:

A determining subunit is configured to randomly determine a standby template video among the plurality of three-dimensional template videos and display the standby template video in response to no target object being detected in a behavior video acquisition area;

A second generation subunit is configured to generate the merged video according to the behavior video of the target object and display the merged video in response to detecting the target object in the behavior video acquisition area.

In some embodiments, the video processing device provided by the present disclosure further includes the following:

A collection subunit is configured to collect barcode information displayed by a user in response to a user login request;

A login subunit is configured to determine a target account corresponding to the barcode information, and the target account is used to log in.

In some embodiments, the video processing device provided by the present disclosure further includes the following:

A saving subunit is configured to save the merged video in a storage location corresponding to the target account in response to a merged video download instruction.

During specific implementations, each of the above units may be implemented as an independent entity, or may be combined arbitrarily to be implemented as the same or several entities. For the specific implementations of each of the above units, reference may be made to the foregoing method embodiments, and details are not repeated here.

According to the above description, it can be seen that in the video processing device provided by the embodiment of the present disclosure, the acquisition unit 201 is configured to acquire the behavior video of the target object; the analyzing unit 202 is configured to analyze the behavior video to obtain the behavioral intent of the target object; the determining unit 203 is configured to determine the target template video matching the behavioral intent among the plurality of preset three-dimensional template videos, the plurality of three-dimensional template videos are three-dimensional videos related to the virtual object; the generation unit 204 is configured to generate the merged video of the target object and the virtual object based on the behavior video and the target template video.

In this way, the video processing method provided by the present disclosure not only provides three-dimensional video templates for merging, but also makes a three-dimensional performance of the merged video better. Moreover, it can automatically match the most suitable three-dimensional template video for merging according to a motion intention of a merged object, making the merged video more vivid and reasonable, and greatly enhancing the realism of the merged video.

An embodiment of the present disclosure also provides a computer device, and the computer device may be a terminal or a server. As shown in FIG. 8, which is a schematic structural diagram of a computer device provided by the present disclosure. Specifically:

The computer device may include a processing unit 301 of one or more processing cores, a storage unit 302 of one or more storage media, a power module 303, an input module 304, and other components. Those skilled in the art can understand that the structure of the computer device shown in FIG. 8 does not constitute a limitation on the computer device, and may include more or less components than those shown in the figure, or combine some components, or arrange different components.

The processing unit 301 is a control center of the computer device, is connected to parts of the entire computer device by using various interfaces and lines, and performs various functions of the computer device and processes data by running or executing the software program and/or the module stored in the storage unit 302, invoking data stored in the storage unit 302, and running software. Alternatively, the processing unit 301 may include one or more processing cores. Preferably, an application processor and a modem processor may be integrated into the processing unit 301. The application processor mainly processes an operating system, a user interface, an application program, and the like. The modem processor mainly processes wireless communication. It may be understood that the foregoing modem processor may alternatively be not integrated into the processing unit 301.

The storage unit 302 may be configured to store software programs and modules. The processing unit 301 executes various function applications and performs data processing by running the software programs and the modules that are stored in the storage unit 302. The storage unit 302 may mainly include a program storage area and a data storage area. The program storage area may store an operating system, an application program required by at least one function (such as a sound playback function, an image playback function, and web page access), and the like. The data storage area may store data created based on use of the computer device, and the like. In addition, the storage unit 302 may include a high speed random access memory, and may further include a non-volatile memory such as at least one magnetic disk storage device, a flash memory, or another volatile solid-state storage device. Correspondingly, the storage unit 302 may also include a storage controller to provide the processing unit 301 with access to the storage unit 302.

The computer device may include the power module 303. Preferably, the power module 303 may use a power management system to connect with the processing unit 301, thereby managing the charging, discharging, and other power management functions by the power management system. The power module 303 may include one or more DC or AC power sources, recharging systems, a power failure detection circuit, a power converter or inverter, a power status indicator, and other arbitrary components.

The computer device may also include an input module 304. The input module 304 can be used to receive input numbers or character information, and generate input of signals from keyboards, touch screens, mice, joysticks, optical or track balls, which may be related to user configuration and function control.

Although not shown, the computer device may also include a display unit, etc., which will not be repeated here. Specifically, in this embodiment, the processing unit 301 in the computer device loads executable files corresponding to the processes of one or more application programs into the storage unit 302 according to the following instructions. The application program stored in the storage unit 302 is run by the processing unit 301, thereby realizing various functions as follows:

The behavior video of the target object is acquired. The behavior video is analyzed to obtain the behavioral intent of the target object. The target template video matching the behavioral intent is determined among the plurality of preset three-dimensional template videos. The plurality of three-dimensional template videos are three-dimensional videos related to the virtual object. The merged video of the target object and the virtual object is generated based on the behavior video and the target template video.

It should be noted that the computer device provided in the embodiment of the present disclosure belongs to the same idea as the method in the above embodiments, and the specific implementation of the above operations can refer to the above embodiments, and will not be repeated here.

Those skilled in the art can understand that all or part of the steps in the various methods of the above embodiments can be completed by instructions, or by related hardware controlled by instructions. The instructions can be stored in a computer-readable storage medium, and loaded and executed by a processor.

Accordingly, an embodiment of the present disclosure provides a computer-readable storage medium in which a plurality of instructions are stored. The instructions can be loaded by the processor to execute the steps in any method provided by the embodiments of the present disclosure. For example, the instructions can perform the following steps:

The behavior video of the target object is acquired. The behavior video is analyzed to obtain the behavioral intent of the target object. The target template video matching the behavioral intent is determined among the plurality of preset three-dimensional template videos. The plurality of three-dimensional template videos are three-dimensional videos related to the virtual object. The merged video of the target object and the virtual object is generated based on the behavior video and the target template video.

For the specific implementation of the above operations, reference may be made to the foregoing embodiments, and details are not repeated here.

The computer-readable storage medium may include: read-only memory (ROM), random access memory (RAM), magnetic disk, optical disk, and the like.

Due to the instructions stored in the computer-readable storage medium, the steps in any one of the methods provided by the embodiments of the present disclosure can be performed. Therefore, advantages that can be achieved by any method provided by the embodiments of the present disclosure can be realized, see the previous embodiments for details, and will not be repeated here.

According to an aspect of the present disclosure, a computer program product or a computer program is provided. The computer program product or the computer program includes computer instructions. The computer instructions are stored in a storage medium. The processor of the computer device reads the computer instructions from the storage medium. The processor executes the computer instructions, so that the computer device executes the methods provided in various alternative implementation manners in the above video processing method.

The video processing method, the device, and the computer-readable storage medium provided by the embodiments of the present disclosure have been introduced in detail above. In this specification, specific examples are used to illustrate the principle and implementation of the present disclosure. The descriptions of the above embodiments are only used to help understand the method and core idea of the present disclosure. At the same time, for those skilled in the art, according to the idea of the present disclosure, there will be changes in specific implementation methods and application ranges. In summary, the contents of this specification should not be interpreted as limiting the present disclosure.

1. A video processing method, wherein the method comprises:
acquiring a behavior video of a target object;
analyzing the behavior video to obtain a behavioral intent of the target object;
determining a target template video matching the behavioral intent among a plurality of preset three-dimensional template videos, wherein the plurality of three-dimensional template videos are three-dimensional videos related to a virtual object; and
generating a merged video of the target object and the virtual object based on the behavior video and the target template video.

2. The method according to claim 1, wherein the generating the merged video of the target object and the virtual object based on the behavior video and the target template video comprises:
acquiring a first relative position of the target object and a behavior video photographing point;
acquiring a second relative position of the virtual object and a virtual video viewing point in the target template video, wherein the virtual video viewing point is a virtual position corresponding to the video photographing point;
adjusting a position of the virtual object in the target template video based on the first relative position and the second relative position; and
generating the merged video of the target object and the virtual object according to the adjusted position of the virtual object.

3. The method according to claim 2, wherein the adjusting the position of the virtual object in the target template video based on the first relative position and the second relative position comprises:
determining a moving direction of the virtual object based on the first relative position and the second relative position;
acquiring a three-dimensional moving template video from the plurality of preset three-dimensional template videos; and
generating a video for adjusting the position of the virtual object based on the three-dimensional moving template video and the moving direction.

4. The method according to claim 2, wherein the acquiring the second relative position of the virtual object and the virtual video viewing point in the target template video, the virtual video viewing point being the virtual position corresponding to the video photographing point comprises:
acquiring a preset viewing angle for viewing the target template video;
determining a virtual viewing point based on the preset viewing angle; and
determining the second relative position of the virtual viewing point and the virtual object in the target template video.

5. The method according to claim 1, wherein the analyzing the behavior video to obtain the behavioral intent of the target object comprises:
extracting a motion data in the behavior video; and
performing an intent matching on a preset behavioral intent database according to the motion data to obtain the behavioral intent of the target object.

6. The method according to claim 1, wherein the method further comprises:
if the target object is not detected in a behavior video acquisition area, randomly determining a standby template video among the plurality of three-dimensional template videos and displaying the standby template video;
if the target object is detected in the behavior video acquisition area, generating the merged video according to the behavior video of the target object and displaying the merged video.

7. The method according to claim 6, wherein before the randomly determining the standby template video among the plurality of three-dimensional template videos and displaying the standby template video if the target object is not detected in the behavior video acquisition area, the method further comprises:
in response to a login request of a user, acquiring barcode information displayed by the user;
determining a target account corresponding to the barcode information, and using the target account to log in.

8. The method according to claim 7, wherein the method further comprises:
in response to a merged video download instruction, saving the merged video in a storage location corresponding to the target account.

9. The method according to claim 1, wherein the acquiring the behavior video of the target object comprises:
in response to a video merging request, sending a video photographing instruction to a camera so that the camera acquires the behavior video in a preset behavior video acquisition area; and
receiving the behavior video of the target object returned by the camera.

10. The method according to claim 9, wherein the in response to the video merging request, sending the video photographing instruction to the camera so that the camera acquires the behavior video in the preset behavior video acquisition area comprises:
in response to the video merging request, sending a detection instruction for detecting the target object in the preset behavior video acquisition area to the camera; and
if it is determined that the target object is detected in the preset behavior video acquisition area according to a detection result returned by the camera, sending the video photographing instruction to the camera, so that the camera acquires the behavior video.

11. The method according to claim 10, wherein the method further comprises:
if it is determined that the target object is not detected in the preset behavior video acquisition area according to the detection result returned by the camera, sending a movement instruction to the camera, wherein the movement instruction is configured to control the camera to move along a preset slide rail until the target object is detected.

12. A video processing device, wherein the device comprises:
an acquisition unit configured to acquire a behavior video of a target object;
an analyzing unit configured to analyze the behavior video to obtain a behavioral intent of the target object;
a determining unit configured to determine a target template video matching the behavioral intent among a plurality of preset three-dimensional template videos, wherein the plurality of three-dimensional template videos are three-dimensional videos related to the virtual object; and
a generation unit configured to generate a merged video of the target object and the virtual object based on the behavior video and the target template video.

13. The device according to claim 12, wherein the generation unit comprises:
a first acquisition subunit configured to acquire a first relative position of the target object and a behavior video photographing point;
a second acquisition subunit configured to acquire a second relative position of the virtual object and a virtual video viewing point in the target template video, wherein the virtual video viewing point is a virtual position corresponding to the video photographing point;
an adjustment subunit configured to adjust a position of the virtual object in the target template video based on the first relative position and the second relative position; and
a first generation subunit configured to generate the merged video of the target object and the virtual object according to the adjusted position of the virtual object.

14. The device according to claim 13, wherein the adjustment subunit comprises:
a first determining module configured to determine a moving direction of the virtual object based on the first relative position and the second relative position;
a first acquisition module configured to acquire a three-dimensional moving template video from the plurality of preset three-dimensional template videos; and
a generation module configured to generate a video for adjusting the position of the virtual object based on the three-dimensional moving template video and the moving direction.

15. The device according to claim 13, wherein the second acquisition subunit comprises:
a second acquisition module configured to acquire a preset viewing angle for viewing the target template video;
a second determining module configured to determine a virtual viewing point based on the preset viewing angle; and
a third determining module configured to determine the second relative position of the virtual viewing point and the virtual object in the target template video.

16. The device according to claim 12, wherein the analyzing unit comprises:
an extracting subunit configured to extract a motion data in the behavior video; and
a matching subunit configured to perform an intent matching on a preset behavioral intent database according to the motion data to obtain the behavioral intent of the target object.

17. The device according to claim 12, wherein the device further comprises:
a determining subunit configured to randomly determine a standby template video among the plurality of three-dimensional template videos and display the standby template video in response to no target object being detected in a behavior video acquisition area; and
a second generation subunit configured to generate the merged video according to the behavior video of the target object and display the merged video in response to detecting the target object in the behavior video acquisition area.

18. A computer-readable storage medium, on which a plurality of instructions are stored, wherein the instructions are suitable for being loaded by a processor to execute
acquiring a behavior video of a target object;
analyzing the behavior video to obtain a behavioral intent of the target object;
determining a target template video matching the behavioral intent among a plurality of preset three-dimensional template videos, wherein the plurality of three-dimensional template videos are three-dimensional videos related to a virtual object; and
generating a merged video of the target object and the virtual object based on the behavior video and the target template video.

19. The computer-readable storage medium according to claim 18, wherein in the generating the merged video of the target object and the virtual object based on the behavior video and the target template video, the instructions are loaded by the processor to execute:
acquiring a first relative position of the target object and a behavior video photographing point;
acquiring a second relative position of the virtual object and a virtual video viewing point in the target template video, wherein the virtual video viewing point is a virtual position corresponding to the video photographing point;
adjusting a position of the virtual object in the target template video based on the first relative position and the second relative position; and
generating the merged video of the target object and the virtual object according to the adjusted position of the virtual object.

20. The computer-readable storage medium according to claim 19, wherein in the adjusting the position of the virtual object in the target template video based on the first relative position and the second relative position, the instructions are loaded by the processor to execute:
determining a moving direction of the virtual object based on the first relative position and the second relative position;
acquiring a three-dimensional moving template video from the plurality of preset three-dimensional template videos; and
generating a video for adjusting the position of the virtual object based on the three-dimensional moving template video and the moving direction.
